(19) United States
(12) Patent Application Publication
(10) Pub. No.: US 2018/0055059 A1
(43) Pub. Date: Mar. 1, 2018

(54) FLATBREAD MACHINE WITH AN AUTOMATIC FLATBREAD PREPARATION METHOD BASED ON DOUGH CAPSULES AND A PACKAGING SYSTEM

(71) Applicants: Carlos Alberto Ruiz Preciado, Zurich (CH); Jonas Mueller, Zurich (CH); Louis Renaud Paul Francois Frachon, Zollikon (CH)

(72) Inventors: Carlos Alberto Ruiz Preciado, Zurich (CH); Jonas Mueller, Zurich (CH); Louis Renaud Paul Francois Frachon, Zollikon (CH)

(73) Assignee: FLATEV AG, Zurich (CH)

(21) Appl. No.: 15/806,119

(22) Filed: Nov. 7, 2017

Related U.S. Application Data
(63) Continuation-in-part of application No. 14/379,546, filed on Aug. 19, 2014.

(30) Foreign Application Priority Data
Feb. 22, 2012 (EP) 12156609.5

(51) Int. Cl. A21B 5/02

(52) U.S. Cl. CPC A21B 5/02; A21D 10/025

(57) ABSTRACT

A capsule for receiving a portion of dough for producing a single piece of flat bread includes a first part and a second part sealingly closable for gastight encapsulation of a dough portion in a hollow portion for making a single piece of flat bread. A preferred execution of this capsule comprises a dome-like part with a radially extending circular edge section, which forms a groove along the circumference of an edge. The groove extends with its depth into the direction of the side of the dome-like part. The sealing foil spans over the opening of the dome-like part (80) and the edge section and groove and it is sealingly weldable or gluable onto the edge section for encapsulating a dough portion.

### CROSS-REFERENCE TO RELATED APPLICATION

This is a continuation-in-part of U.S. patent application Ser. No. 14/379,546, filed Aug. 19, 2014, which represents the U.S. National Phase, pursuant to 35 U.S.C. §371, of P.C.T. Application No. PCT/IB2013/051418, filed Feb. 21, 2013.

### BACKGROUND OF THE INVENTION

Flatbreads are being produced by the millions every day. In most cases, flatbreads are prepared whenever they are needed. But the traditional preparation of homemade fresh flatbreads is till today extreme laborious. In order to prepare fresh dough for flatbreads with the right consistency and flavor, it takes a lot of time, it requires know-how and some experience. Although the existing domestic machines or more industrialized machines for small enterprises, as restaurants, try to simplify this work, the preparation of homemade flatbread is still very laborious. Nowadays machines which are able to produce tortillas at a fully automated process are very costly, big and have to be monitored by humans. Therefore they are not very likely to be installed in any household. These are some reasons why many consumers or small enterprises buy industrially manufactured flatbreads which are often made in relatively large quantities, as the Mexican tortilla, and then refrigerated for a later consumption. Those flatbreads which are widely available suffer in quality to some extent by mass production and the natural decrease in freshness because of shelf time or the use of preservatives.

By mixing the dough flour, water and other ingredients there are many factors that may influence the consistency and texture of the dough. For example the temperature of the water may affect the consistency or if the dough is chemically or yeast leavened. This preparation process may be the most complicated to achieve by persons without enough experience, know-how or time.

While patents, such as U.S. Pat. No. 5,366,744 from Drummond et al., describe a method for making packaged leavened dough suitable for extended refrigerated storage, this method does not provide an automatic separation of the dough from the tray. The consumer must remove the dough product from the tray at the time of baking and place the dough product on a baking sheet or other appropriate baking utensil.

At present, there are only pre-baked flatbreads available on the market. These are flatbreads which were baked for a part-time of the entire baking process and then packaged into plastic packagings. Before eating, those pre-baked flatbreads are finished and fully baked either in a stove or in a microwave device. However, the taste of such flatbreads never reach the richness and freshness of handmade and instantly made flatbreads.

### SUMMARY OF THE INVENTION

It is therefore an objective of the present invention to provide a new method and apparatus or the fully automatic and instant preparation and baking of flatbreads of all kinds and sorts. The invention also comprises a means for the intermediate packaging and storage of dough portions for distribution and for storage in such an apparatus so the apparatus is able to deliver fresh made flatbreads at any time and instantly.

The invention therefore provides a method for a fully automatic preparation of flatbread such as tortilla, naan, ruti, piadina, etc. with a flatbread machine for use at home or in enterprises that can bake and deliver fresh made flatbreads at any time—just at the push of a button. The innovation includes dough portions packed in capsules that include a system which enables the dough to be suitable for extended refrigerated and unrefrigerated storage.

In the figures, various aspects of the method, the packaging of the dough portions and apparatus for processing the dough portions and its baking and delivery are shown by way of examples.

### BRIEF DESCRIPTION OF THE DRAWING FIGURES

In the figures, various aspects of the method, the packaging of the dough portions and apparatus for processing the dough portions and its baking and delivery are shown by way of examples.

In the drawing figures:

FIG. 1: The working principle of the method and apparatus by way of a schematic view of the apparatus;

FIG. 2: The working principle of the method and apparatus by way of a schematic view of the apparatus;

FIG. 3: A capsule containing a portion of dough for one single flatbread;

FIG. 4: The two halves of a capsule containing a portion of dough for one single flatbread;

FIG. 5: The two halves of another type of a capsule containing a portion of dough for one single flatbread;

FIG. 6: The opening and emptying of a capsule containing a portion of dough for one single flatbread;

FIG. 7: The moment when the dough portion is falling out of the capsule;

FIG. 8: one single cylindrical capsule with its cover;

FIG. 9: a row of cylindrical capsules closed on their bottom side;

FIG. 10: The pouring out of a single dough portion out of a capsule of a moving row of capsules;

FIG. 11: Another way of isolating single dough portions out of capsules of a moving row of another type of capsules;

FIG. 12: The flattening of a dough portion within the apparatus;

FIG. 13: The baking of a dough portion squeezed in between two hot plates;

FIG. 14: The flattening of a dough portion by a rolling pin within the apparatus;

FIG. 15: The flattening of a dough portion by pressing shells within the apparatus;

FIG. 16: The delivering of a baked flat bread after completing of the baking process, by turning the baking plate;

FIG. 17: The delivering of a baked flat bread after completing of the baking process, by moving the two-parts of the baking plate apart;

FIG. 18: A sophisticated flat bread machine in a view open on one side;

FIG. 19: The flat bread machine according to FIG. 18 in a view open on the opposite side;

FIG. 20: Another flat bread machine in a view open on one side, functioning with another method for opening the dough capsules;

FIG. 21: A dough capsule in the shape of a cup with its top sealed by a foil;

FIG. 22: A collapsible dough capsule in the shape of a cup with predetermined folding lines;

FIG. 23: The collapsible dough capsule according to FIG. 22 in the collapsed state;

FIG. 24: A dough capsule in the shape of a cup with its top sealed by a foil, and with an upper edge forming a surrounding groove;

FIG. 25: A dough capsule in the shape of a cup with its top sealed by a foil, and with an upper edge forming a surrounding groove and with predetermined folding lines;

FIG. 26: A circular disc shaped foil piece with a weakening line, for sealing a cup-shaped dough capsule;

FIG. 27: A circular disc shaped foil piece with several weakening lines across the foil piece, for sealing a cup-shaped dough capsule;

FIG. 28: A circular disc shaped foil piece with crossing weakening lines, for sealing a cup-shaped dough capsule;

FIG. 29: A ball shaped dough capsule consisting of two hollow hemispheres;

FIG. 30: A ball shaped dough encapsulated in an evaporizable foil;

FIG. 31: A flat bread dough encapsulated in an evaporizable foil;

FIG. 32: A flat bread dough packaged and encapsulated in foil material;

FIG. 33: flat bread dough capsules piled up and packed in a stack;

FIG. 34: flat bread dough capsules arranged in a blister packaging;

FIG. 35: Flat bread dough capsules arranged in a row in a cardboard box;

FIG. 36: A flat bread dough capsule before inserting into the machine by a pokayoke-system;

FIG. 37: A flat bread dough capsule conveying system for feeding the flat bread machine;

FIG. 38: A flat bread dough capsule conveyer carousel for feeding the flat bread machine;

FIG. 39: A flat bread dough capsule stack for feeding the flat bread machine;

FIG. 40: A flat bread dough capsule opening system for tearing the sealing foil off the capsule;

FIG. 41: A collapsible flat bread dough capsule before cutting open the sealing foil and before collapsing it;

FIG. 42: The collapsible flat bread dough capsule of FIG. 41 after cutting open the sealing foil and pressing down the bottom of the capsule by a piston, so the capsule collapsed and the dough fell down;

FIG. 43: A system for opening a ball-shaped capsule by means of rails that are spreading away;

FIG. 44: A capsule consisting of two sealingly connected shells with orifices and a system for receiving, opening, discharging and disposing such capsules;

FIG. 45: The capsule and system of FIG. 44 while opening and discharging the capsule;

FIG. 46: The capsule and system of FIG. 44 while disposing the capsule;

FIG. 47: Press plates for a parallel closing and flattening the dough balls;

FIG. 48: Press plates with a lower horizontal resting plate and an upper swiveling plate for flattening the dough balls;

FIG. 49: Press plates with an upper horizontal plate and a lower swiveling plate for flattening the dough balls and subsequently releasing the flat dough;

FIG. 50: Press plates with an upper and lower swiveling plate for flattening the dough balls and subsequently releasing the flat dough;

FIG. 51: Press plates with an upper and lower horizontal plate, the upper plate having a removable stamp for creating a temporary hole for inserting the dough ball;

FIG. 52: Press plates which comprise releasable heating plates for cleaning purposes;

FIG. 53: A table presenting the pressing and heating process by showing the distance between the heating plates versus the time for three different temperatures;

FIG. 54: A section view of the dome-like capsule;

FIG. 55: A bottom view of the dome-like capsule;

FIG. 56: An enlarged view of the circumferential edge of the dome-like capsule; and,

FIG. 57: A perspective view of the open capsule, with its sealing foil.

### DETAILED DESCRIPTION OF THE DRAWING FIGURES AND PREFERRED EMBODIMENTS

The starting point of the invention is a packaging system for the intermediate storage of a suitable dough. The dough is encapsulated in capsules which comprise a single portion for one single flatbread. In this form and shape, the dough portions can be stored for a period of at least three weeks. The capsules are specifically designed for an automatic opening and processing with a flatbread machine. The flatbread machine system is capable of preparing at least one flatbread from dough packed inside capsules fully automatic, without the user having to open or remove something from each encapsulated dough by oneself.

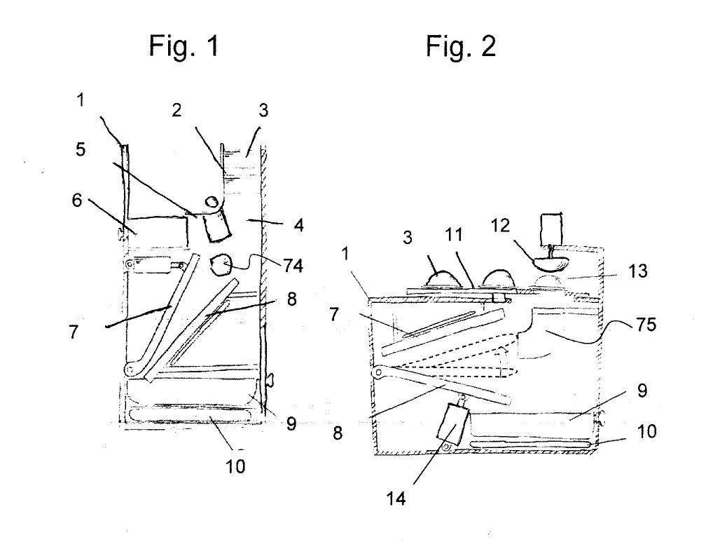

As shown in FIG. 1, the machine or apparatus comprises these elements which are shown in schematic manner: A housing 1, containing a feeding compartment 2 which receives the capsules 3 containing a dough portion each. The capsules 3 will be transported by a conveyor system 4 toward the baking plates 7, 8, then opened and emptied by an opening system 5. The empty capsules are being conveyed into a waste recipient 6, and the dough 74 falls in between the baking plates 7, 8 and is then squeezed to a flat shape in between them. Then the heated baking plates 7, 8 start the baking process. When completed, the plates 7, 8 open and eject or release the fresh made flat bread into a recipient 9 which is equipped with a warm keeping system 10.

As shown in figure, 2 in another execution of the apparatus, the capsules 3 are being conveyed to the apparatus in a chain or row 11. They reach an end position in which they are opened mechanically, hydraulically or pneumatically. In the shown example, a plunger 12 of a press 13 moves downward and increases the internal pressure in the capsule. Under this pressure, the sealing foil on the lower side of the capsule 3 will burst and the dough portion then falls through the leading pipe 75 in the housing 1 of the machine and down between the baking plates 7,8.

The lower baking plate 8 is swivelable upwards along the indicated arrow, by a pneumatically, hydraulically, electrically or mechanically activated piston 14. After completion of the baking process, the lower baking plate 8 is swiveled down again and the finished flat bread slits down into the recipient 9 where the flat breads are kept warm by a warm keeping system 10. Automatically, the next dough capsule 3 is placed underneath the plunger 12 for preparing a next flat bread on request. If the machine contains more capsules 3 inside, the machine begins with the process again and again until the feeding compartment or the row 3 is emptied and all flatbreads have been made. The user can finally remove the flatbread recipient 9 with all finished flatbreads cooked like a drawer.

As mentioned earlier, this invention comprises a dough capsule 3 which is defined here as a container, a pad or a package that contains at least one portion of fresh dough for making flatbreads such as tortillas, naan, pita, ruti, piadina, etc. The form of the dough capsule can be round, chub, cylinder (can or canister), pouch, square, rectangular, triangular, etc. Depending on the functioning of the machine and its corresponding opening system the capsule can be composed of at least one single piece that surrounds and closes the dough mass. The form of the capsule should allow the machine system to open and separate or liberate the dough from the capsule automatically, without the user having to open or remove something. However the form should be also simple and packable with low volume in order to make sense economically.

The material should primarily maintain the dough as long as possible by both refrigerated and unrefrigerated storage without affecting the consistency and backing characteristics of the dough. The material of the capsule may be for example but not limited to, soft, bio degradable, flexible, rigid, semi-rigid or a combination of them. The following materials or a combination of them (aluminum, paper, paperboard, can or canister, plastic or polymeric material), among others not listed here, may be used depending on the dough product and the type of the flatbread machine. Also biodegradable material may be suitable. The material and the form of the capsule should interact with the opening system of the machine in a proper way so that the dough does not stick to the capsule and no rest of capsule material is transported together with the dough to the pressing phase.

The consumer should not open the dough capsule by himself. The dough capsule 3 should be opened only by the flatbread machine's system. The machine system should open the capsule 3 only if the capsule 3 has not been opened or damaged before. This could be done, for example but not restricted to, by a code or chip on the capsule 3 which only the flatbread machine recognizes.

The design of the capsule 3 may include for example a weak point that allows the machine to separate the capsule easily from the dough but at the same time enough safe that no material particle of the capsule 3 comes in together with the dough by the separation and transportation to the next level.

To form a homogeneous dough mass flour, water, salt and other components such as yeasts or other microorganisms, leavening agents, emulsifiers, enzymes, etc. are mixed in adequate amounts. Depending on the dough product, different kinds of flour may be used. For example white, yellow and blue corn (Zea maize) flour for corn tortillas or wheat flour for wheat tortillas, or teff and other basic ingredients can be used for producing even other types of flatbreads. In addition components such as jalapenos, tomato, cheese, honey, garlic and other herbs and spices as well as taste giving liquids such as wine, beer, soy sauce may be added to the dough mass. The dough may be yeast or chemical leavened and it may be proofed or un-proofed. Natural yeast (Saccharomyces cerevisae), baking powder (Sodium Bicarbonate) or other yeasts can be used. It can contain suitable preservation ingredients according to the state of the art. The components of the mass are combined and kneaded under circumstances at which the dough mass is developed. A typical recipe of a Corn Tortilla is this: (All percentages given are related to the weight of the dough).
Corn-Flour: 46+-5% dried, nixtamalized corn flour, moisture: 13%+-2%
Water: 54+-5% temperature, 80-95° C. (soft water)
Additives: <=2% salt or other preservatives as alcohol, sodium bicarbonate, sodium propionate, potassium sorbate, sorbic acid or other NDA conform ingredients.

A typical recipe for a Wheat Torilla is this: (All percentages given are related to the weight of the dough).
Wheat-Flour: 68%, white flour type 440, protein content: 9.5-11.5%, water content 13-14%
Water: 27.5%
Salt: 1%
Fat Vegetable: 2%
Baking powder: 1%
Acidulant: 0.3%
Preservation: 0.13%
Dough conditioner: variable

The preservatives used can be those indicated above. Salt or other preservatives as alcohol, sodium bicarbonate, sodium propionate, potassium sorbate, sorbic acid or other NDA conform ingredients can be used, whatever is preferred. A correct Tortilla is not thicker than about 6 mm, and it can have a round, rectangular oval or other shape. Important is mainly its taste which highly depends on its freshness!

The user turns the machine on by enabling electricity to the machine. Then the user opens the machine's feed compartment for example by pushing a button or by pulling the compartment out. Then the user puts at least one dough capsule into the machine's feed compartment without opening the capsule or removing something of it. This may happen for example, but not limited to, by putting each dough capsule into a specific place of the compartment, for example by a revolver system, or by putting each dough capsule, for example into a feed system shaped as rail where the capsules are placed one after one. After this, the user closes the machine's feed compartment for example by pushing a button or by pushing the compartment into the machine.

The machine opens the dough capsules 3 fully automatically without the consumer having to open s or remove something of the capsule 3. This can happen for example, but not limited to, through pressure to the capsule 3 in different ways or by cutting a part of the capsule in order to break it and separate it from the dough.

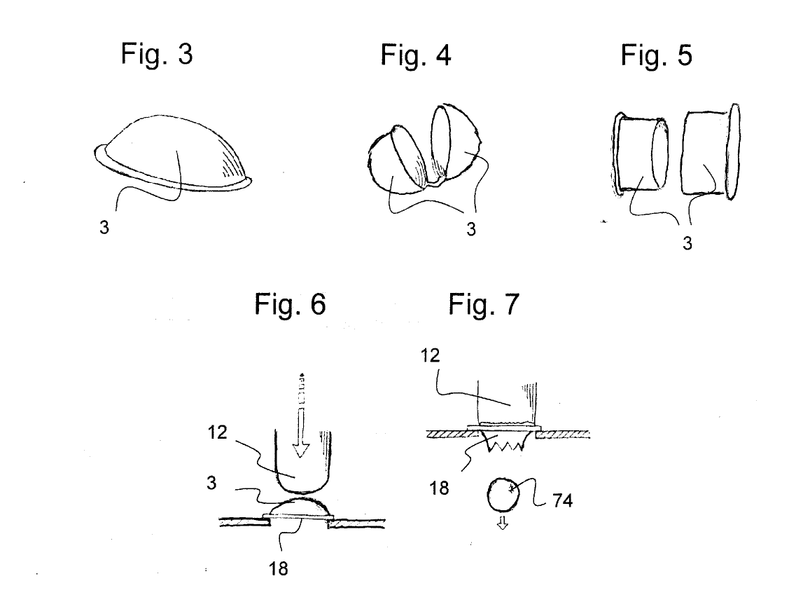

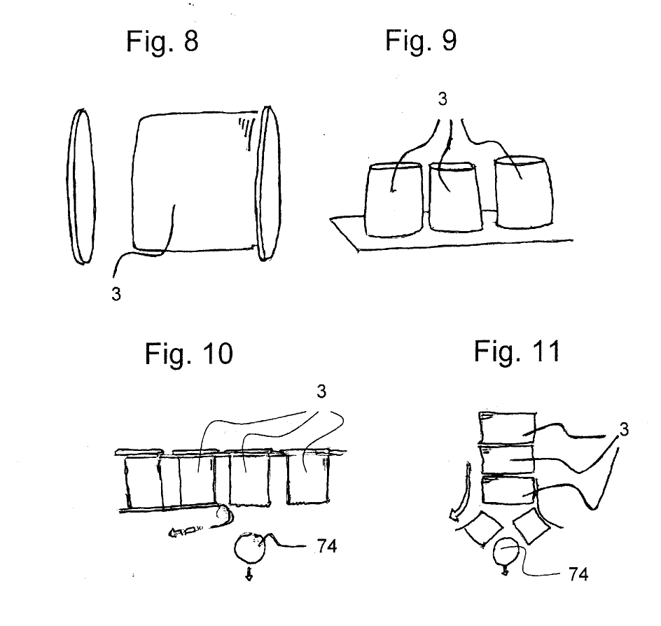

The following examples illustrate possible capsules 3 and their opening systems. If for example the dough capsule 3 is made from a semi-rigid material such as plastic, e.g. polypropylene (PP) or aluminum and the form of capsule 3 is round as shown in FIG. 3, the machine can push a the top of the dough capsule with a plunger in order to originate pressure on a special point of the capsule 3, so that the capsule 3 gets opened and the dough falls down into the next level of the machine in order to be pressed and then baked.

FIG. 4 shows the two halves of a ball-shaped capsule containing a portion of for one single flatbread. The two halves are fitting together and can be welded or glued together along their round edges by way of common methods.

Another example with a cylindrical form with special two rigid borders and with a combination of rigid material from aluminum by the body of the capsule and a semi-rigid material from aluminum by a special weak point of the capsule in the middle is shown in FIG. 5. The part on the left side of the figure can be plugged into the part of the capsule shown on the right side of the figure. The left edge of the part on the right side is then being welded to the bottom plate of the left part. In FIG. 6 a plunger 12 is shown which presses onto the capsule 3 from above. The foil 18 bursts open and the dough portion 74 falls out as shown in FIG. 7.

The machine feeding system can push or move the capsules in a feeding system in such way that at the end of the feeding system, the parts that hold the two rigid borders of the capsule diverge from each other so that the weak point of the capsule breaks and separate the dough from the capsule and the dough falls finally down to the next level of the machine in order to be pressed, while the two pieces of the capsule are removed or transported to the waste container of the machine.

After the dough 74 has been liberated from the capsule, the dough is transported to next level where the dough is going to be pressed by falling down for example direct to the pressing system or to a passage, for example a tube, that facilitates the exact positioning of the dough before pressing.

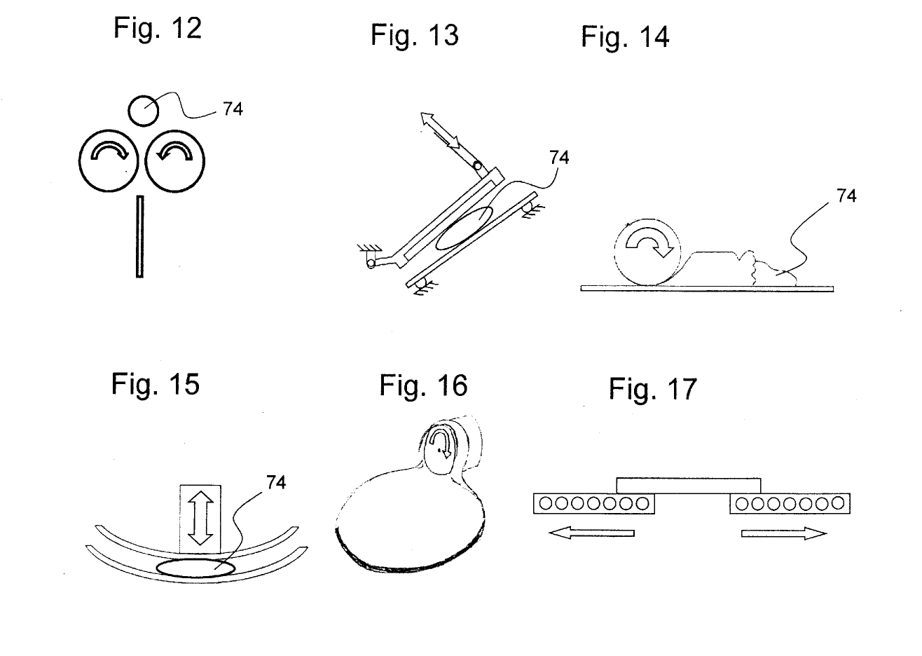

When the dough has reached the appropriate place to be pressed, the dough gets pressed automatically. The pressing system may happen for example, but not limited to it, through two rollers as shown in FIG. 12, or two plates as shown in FIGS. 1, 2 and 13, which may be partially heated up to 218° C. in order to avoid misshaping and the formation of translucent spots. Other press systems as a convex press as shown in FIG. 15 or like toothpaste out of a tube as shown in FIG. 14 may be used. The end material of the parts that have contact with the dough may be for example Teflon or other material that avoids the sticking of the dough to the end material.

After the dough has been pressed, the machine cooks the dough and converting it into a desired fresh flatbread. The heating may happen for example, but not limited to, by induction. By using two plates as shown in FIGS. 1, 2 and 13 for example, they can be heated with induction technology and the dough can be pressed and formed into a disc in seconds. As the plates are cold during the seconds in which the dough gets pressed, the dough would not suffer formation of translucent spots and the shape remains stable. As induction reaches higher temperatures significantly quicker then by electrical heating, the two plates, when they come together by pressing the dough into a flatbread, the plates reach a cooking temperature of more than 260 C.° in seconds and the pressed dough gets cooked instantaneously in order to reach desirable toast marks.

While the dough get's pressed and heated, the material of the opened capsules is being removed or transported to the waste recipient automatically. After the flatbread is cooked and ready to eat, it is transported to the removable flatbread recipient, which retains more than one flatbread warm with a warm keeping system 10. The transportation of the cooked flatbread to the removable warm recipient may happen for example, but not limited to, by moving or rotating the plate on one of the sides downwardly, in order that the flatbread falls down from that side as shown in FIG. 16, or by separating the bottom plate in two parts and driving them apart so that the tortilla falls down in the middle as shown in FIG. 17.

If the machine contains more capsules inside, the machine begins with the process again until the feed compartment gets empty and all flatbreads have been made. The user can finally remove the flatbread recipient with all flatbreads cooked and ready to eat.

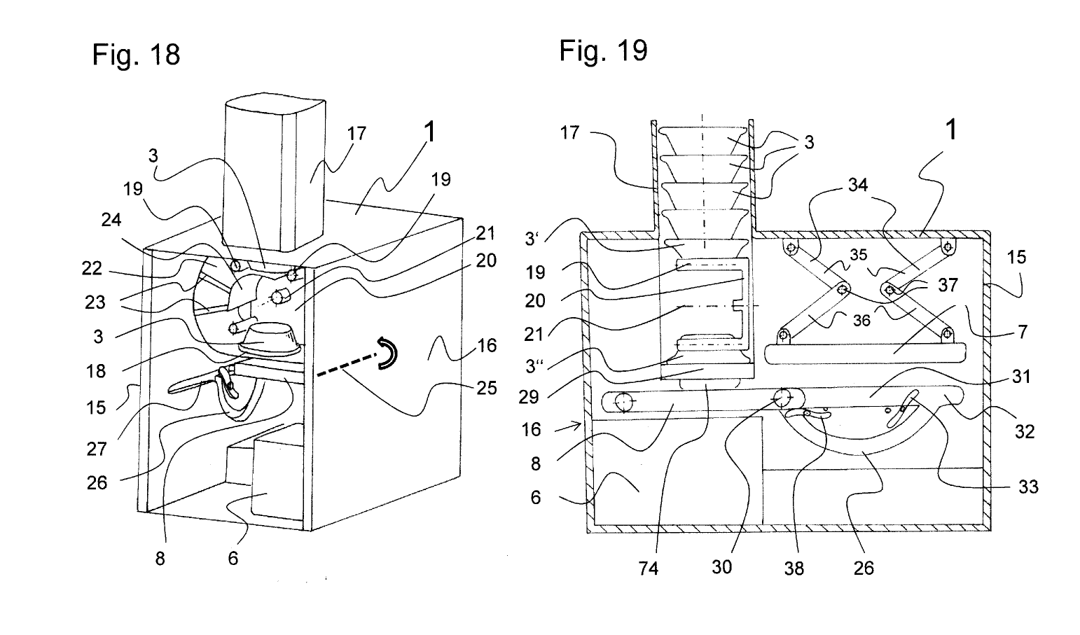

In the following, particular executions of the method and machine are being disclosed. FIG. 18 does show a more sophisticated flat bread machine in a view open on one side. Side 15 is the front side of the machine, side 16 is the rear side of the machine. The machine comprises a housing 1, and on top of it, a container 17 for the capsules to be fed into the machine is shown. One side of the machine housing 1 is here opened since the respective cover plate of the housing 1 was removed in order to give free sight into the interior of the machine. What can be seen in this drawing is the mechanism by which the capsules 3 are being handled once they are fed into the machine from the container 17 in which they are stacked. The capsules 3 used here have the shape of a collapsible cup. The upper opening of the cup is sealed with a gas-tight foil 18, and the cup contains a portion of dough for the single flat bread to be prepared. Capsule 3 and dough must not be form-fitting in order to ensure an easy emptying of the capsule, rather, the dough should not fill the cup-shaped capsule but leave a distance of approx. 5 mm to the covering foil 18. The cups are stacked upside up in the container 17. The lowest cup or capsule 3 in the container 17 can be seen partly. It is being hold by two fingers 19 which are extending perpendicularly from a rotatable disc 20 which is rotable around the horizontal axis 21. This disc 20, when activated, does rotatable in counterclock direction in the shown drawing. While rotating, the disc's fingers 19 hold a cup-shaped capsule 3 between them and rotate the same around the central axis 21. The foil-side of the cup is then gliding along the inner side of the cylindrical wall 22. This cylindrical wall 22 is being hold by several struts 23 that are connected to an inner cylindrical wall 24 having a smaller radius. The disc 20 and its fingers 19 rotate until the cup is placed upside down on a holding plate having a central hole (not shown in this drawing). The edge of the cup-opening rests on the edge of the hole and then, a plunger (not shown in this drawing) moves down, collapses the cup by pressing onto its bottom side, thereby cutting or bursting open the sealing foil 18. Consequently, the dough portion in the capsule 3 will fall down through that hole onto the lower baking plate 8. An optical sensor recognizes when the dough has fallen down onto said plate 8. This baking plate 8 is movable in horizontal direction to the left, in order to reach the horizontal displaced position in which it is ready to serve as lower pressing plate. An upper pressing and baking plate (not shown in this drawing) is then moving from above downward and squeezes the dough portion between the two plates until the dough assumes a flat bread shape. Then, heating means are actuated, and the dough is being baked. This heating means can comprise electrical heating coils within the plates, or induction heating coils, or even gas burners that heat up the plates. Once the baking process is finished, the lower plate 8 is being pulled back. This lower plate 8 is swivelable around an axis 25 that is indicated with a dotted line and that is movable in its entirety in horizontal direction toward the front side 15 of the machine. In the position of the lower plate 8—displaced to the left from the position as shown in FIG. 18—this plate 8 is first supported by upper rails (not shown) in order to resist the pressing force, and when pulled back, it will be swiveled down around its axis 25 since its front end is then being guided along the lower guiding rails 26 that describe a bow as will be explained in connection with FIG. 19. When the lower plate 8 is swiveled down temporarily, the finished flat bread will glide away from the lower plate 8 and ultimately being dispensed through the slit 27 (FIG. 18) in the front side 15 of the housing 1 of the machine. In the lower back of the machine, a waste recipient container 6 can be recognized. Once the cup or capsule 3 is emptied, disc 20 will further rotate counterclock-wise and shift the capsule 3 toward the backside 16 of the machine where it will fall down into this waste recipient container 6 for waste capsules.

FIG. 19 does show a similar machine when seen from the opposite side, that is from the left side, with opened left side panel of the housing 1. Here one can see the feeding container 17 and the capsules 3 in the form and shape of cups piled up within the container 17 to a stack. The disc 20 is arranged here rotatable around the axis 21 which does extend to the rear wall of the housing 1, and the fingers 19 on the disc 20 are extending in horizontal direction from the disc 20, arranged perpendicularly on said disc 20. The lowest cup 3′ in the container 17 already rests between two fingers 19 of the disc 20, while another cup 3″ has already been rotated around axis 21 in an upside down position onto the holding plate 29 having a central hole. The dough ball 74 has already fallen down and is now resting on the lower pressing and baking plate 8. When the disc 20 further rotates, it will move the upper cup 3′ into the lower upside-down position, and the lower cup 3″ will be disposed into the waste recipient container 6 for the emptied cups or capsules 3. Once the dough ball 74 is placed on the pressing and baking plate 8, said plate 8 will be moved horizontally toward the front side 15 of the machine—in FIG. 19 to the right. On its side at the front end, bolts 30 are extending to the side and these bolts 30 are being guided in guiding rails 26, 31. In a first movement, here from the left to the right, the pressing and baking plate 8 will be moved by a motor in horizontal position while its side bolts 30 are guided along the upper guide rails 31 until the bolts 30 reached the front end of these guide rails 31. In the front end area 32, there are spring-loaded separators 33 arranged. The bolts 30, when moving from the left to the right, will swivel these separators 33 from the shown position into a horizontal position so they give way for the bolts 30 to pass them and ultimately reach the front end 32 of the guide rails 31. In such position of the bolts 30, the pressing and baking plate 8 has reached is operating position for the pressing and baking process. For pressing the dough which is placed on this pressing and baking plate 8, an upper pressing and baking plate 7 is arranged parallel to the lower pressing and baking plate 8. Said upper plate 7 is hanging on a knee-knuckle press mechanism 34. In the shown example, there are two levers 35, 36 on each side. When their central joints 37 are being pushed away from each other, e.g by a mechanical mandrel/spindle, or linear guide unit, or by a hydraulic or pneumatic piston/cylinder arrangement, the upper pressing and baking plate 7 will be lowered down and ultimately press with increasing force onto the dough portion laying on the lower plate 8: The pressing force will increase due to the knee-knuckle effect of the chosen mechanism 34. It is though clear that other mechanisms for actuating such a pressing can be chosen. Once the dough portion is pressed into the shape of a flat bread, the heating process starts by heating up the baking plates 7, 8. The actual baking will be performed at a selected temperature, e.g. between 200° C. and 220° C. for tortilla dough. These temperatures are only given as examples and are not to be understood as definite limits. Depending on the doughs used, lower of higher temperatures may be suitable. The machine can offer a temperature range from 20° C. to 350° C. depending on what is required. Once the dough baking process is finished, the heating is stopped. The upper plate 7 will be lifted up, and the lower plate 8 will be pulled back. Now, when pulling the lower plate 8 back, its side bolts 30 are being guided along the bow-like shaped lower guide rails 26 since the spring loaded separators 33 reassumed the shown position that ensures that the bolts 30 are guided downward into the lower bow-shaped guiding rails 26. Other such separators 38 ensure that the bolts 30 are reaching their initial position as shown in FIG. 19, and for the next movement to the right, they will glide over these separators 38 into the horizontal guide rails 31.

Basically, the feeding compartment 17 can be either integrated into the machine or form an external compartment, e.g. it can be just the container in which the capsules are being distributed. The machine's compartment can easily be refilled in any case. It can cooperate with the conveyer system for feeding the single capsules to the opening and emptying system. The recipient container is designed releasable from the machine, e.g. like a drawer so the empty capsules can easily be removed from the machine.

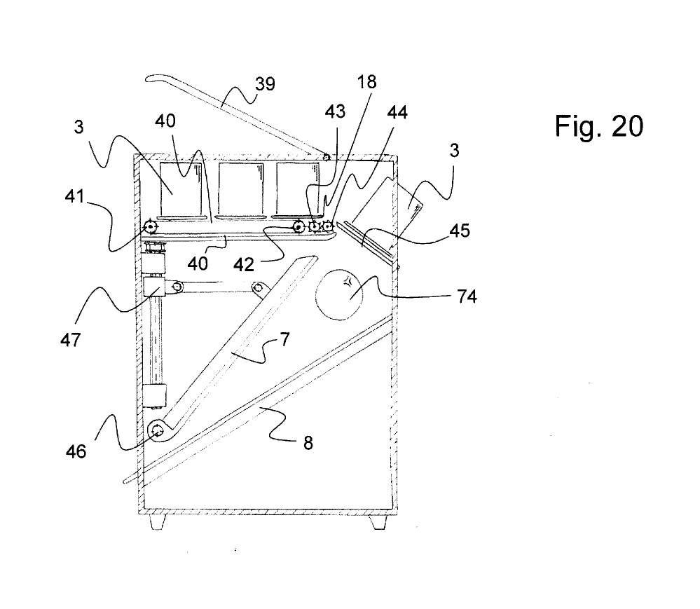

FIG. 20 discloses another flat bread machine in a view open on one side, functioning with another method for opening the dough capsules. The also cup-like shaped capsules 3 with sealing foil 18 over their opening are being inserted upside down into the machine by lifting up a swivable cover plate 39. The capsules 3 are placed on a conveyor belt 40 that runs around two shafts 41, 42. At the front end of said conveyor belt 40, two shafts 43, 44 with rubber teeths extending away radially from the circumference of the shafts 43, 44 move in different directions, the first one 43 clockwise, the adjacent one 44 at the front end in counterclock-wise direction. These shafts have a diameter of approx. 20 mm which proved to work fine. The foils 18 of the capsules 3 have an overlap of approx. 5 mm that is always bent away from the capsules 3 upper edge. Therefore, when the capsules 3 are laying upside down on the conveyer belt 40, these overlaps are under a tension to bend downward. Once the overlap of a capsule 3 reaches the shafts 43, 44 with the rubber teeths, this overlap will be packed by the shafts 43, 44. The second shaft 44 is positioned a bit higher so it will surely grip the foil overlap. The foil 18 is then pulled down between the two shafts 43, 44 and torn away from the edge of the opening of the capsule 3, and the capsule is forced to move over the two shafts 43, 44 and to pass them. Therefore, the foil 18 will be torn away from the capsule 3 and the then open capsule 3 will glide onto the inclined holding ring 45. Instantly, the dough ball 74 will fall out of the capsule and fall in between the two pressing and baking plates 7, 8. An optical sensor recognizes when the dough ball has fallen down in between the plates 7, 8. The upper pressing and baking plate 7 is swivelable around an excentrically arranged axis 46, and an actuator 47 can then swivel the upper pressing and baking plate 7 down onto the lower plate 8. The excentric arrangement of the axis 46 will ensure an increasing pressing force the more the pressing plate 7 did already swivel in downward direction.

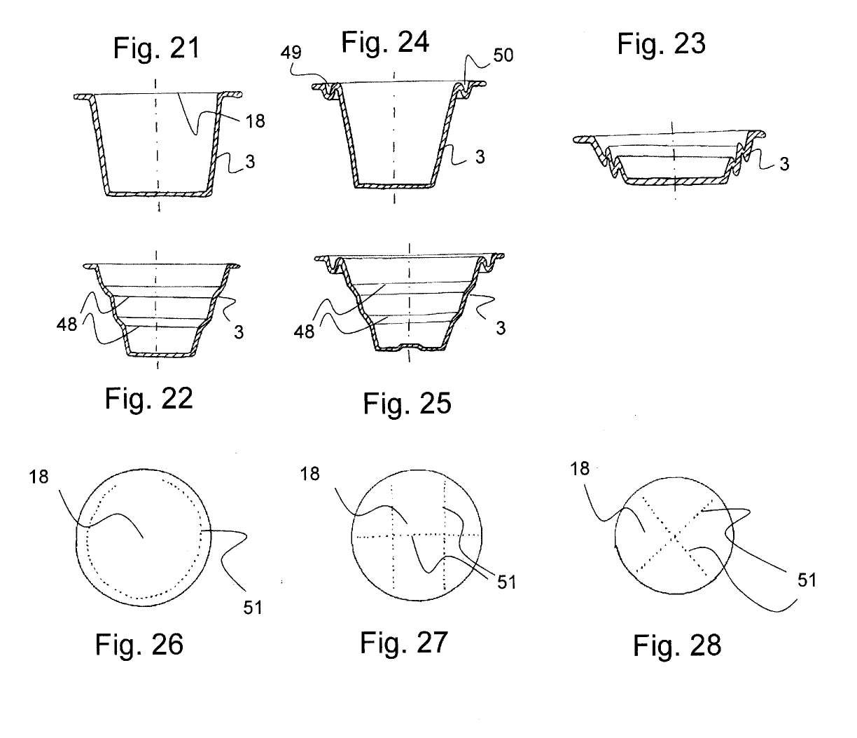

FIGS. 21 to 29 show various types of suitable capsules 3. FIG. 21 e.g. does show a dough capsule 3 in the shape of a cup with its top sealed by a foil 18. The dough portion is being filled into such a capsule 3 under an atmosphere of an inert gas such as Nitrogen. The capsules 3 are made of a gas-tight plastic as known in the food and beverage industry, and the foil is a laminate of aluminum foil that is gas-tight. Semi-permeable foils can be used which allow O₂ to permeate from within the capsule 3 but not in opposite direction. For special purposes these capsules 3 and foils 18 can even be made in oxygen tight manner as known in the state of the art. This type of cup-like capsule 3 can be piled up in empty state, and even a re-use may be an option. In such case, the capsules 3 should be piled up in a recipient container for the emptied cups so they can be easily recycled and brought back to the seller in the original cardboard box in which they are being sold.

FIG. 22 shows a collapsible dough capsule 3 in the shape of a cup with predetermined folding lines 48. Else, the capsule 3 is similar or equal to the one shown in FIG. 21. But this collapsible capsule 3 allows it to reliably empty it form the containing dough. In FIG. 23, the collapsed dough capsule 3 of FIG. 22 is shown in the collapsed state. In order to reach this state, the upside down placed capsule 3 will be pressed from above by a plunger or piston while its opening edge rests on a ring which leaves the space under the opening free so the dough can freely fall through said ring opening once the sealing foil 18 has been opened. For even better ensuring the opening of such capsules, the foil 18 may be equipped with prepared weakening lines, as explained later.

FIG. 24 does show a dough capsule 3 in the shape of a cup with its top sealed by a foil 18, and with an upper edge 49 forming a surrounding circular groove 50. The purpose of this particularly shaped edge and said groove 50 will be explained later, in connection with the opening process as shown in FIGS. 41 and 42. Advantageously, this cup-like capsule 3 is also equipped with folding lines 48 as already described to FIG. 22 and shown here in FIG. 25.

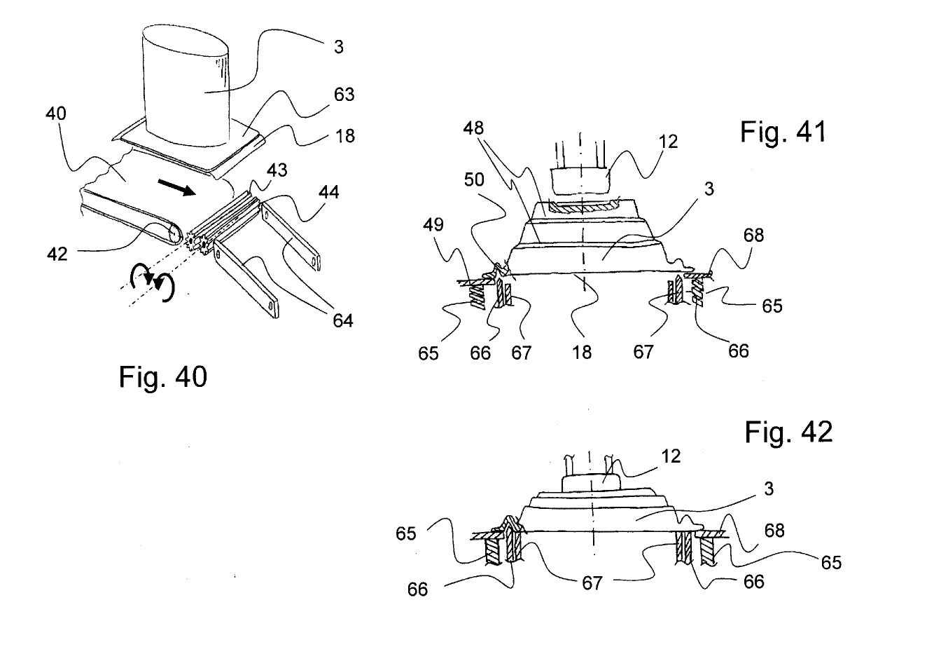

FIG. 26 shows a circular disc shaped foil piece 18 with a weakening line 51, for sealing a cup-shaped dough capsule 3. Such weaking line 51 can be reached making the foil 18 thinner along this line, as already know in the state of the art, e.g. by a hot welding knife that is pressed down onto the foil 18, against a hard support plate. In an alternative way, the weakening lines 51 can be obtained by a fine perforation of a two-layer foil 18 while only one layer of the foil is perforated to keep it airtight. In FIG. 27, the circular disc shaped foil piece 18 is equipped with several weakening lines 51 across the foil piece, and in FIG. 28, the weakening lines 51 form a single cross over the circular foil 18. The foil 18 has two basic purposes on such capsules 3. Firstly, the foil 18 must hermetically close the capsule 3 in order to keep air away from the dough. Secondarily, the foil 18 does ensure that in the course of emptying the capsule 3, the dough never gets in touch we a part of the machine, not even with the knife that opens to foil 18 if such knife is being used. The opening of the capsule 3, however, will be described later, in connection with FIGS. 40, 41 and 42.

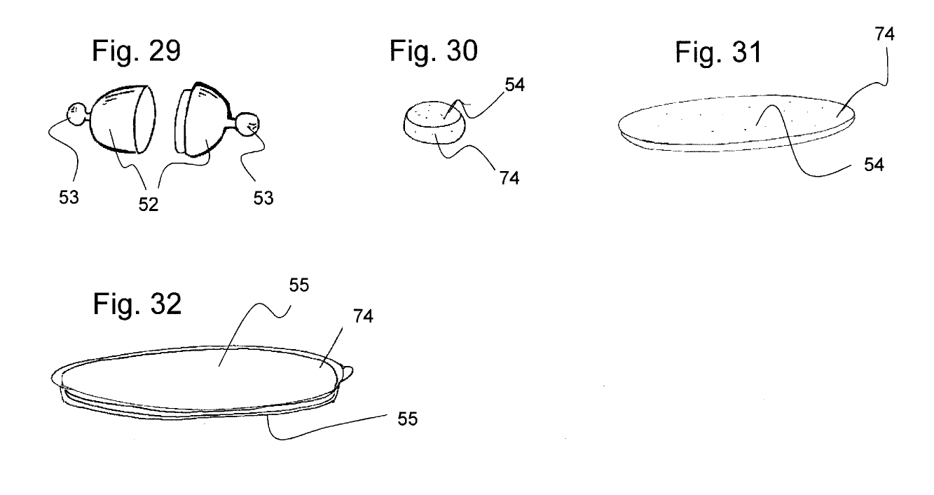

In FIG. 29, an entirely different type of a capsule is shown. This is a ball shaped dough capsule 3 consisting of two hollow hemispherical shells 52 that are equipped with little knobs 53 at their zeniths. The two hemispherical shells 52 can be closed and sealed by heat welding or gluing them together. Then, the dough portion is hermetically enclosed. The handling and opening of such capsules 3 is described later, in connection with FIG. 43.

The capsules can be sold with a second packaging material or not. If the capsule foil is even perforated, it is best to use a second package, e.g. a cardboard box, for guarding their inner foil 18. As yet another type of capsule, FIG. 30 shows a ball shaped dough encapsulated in an evaporizable foil 54 that forms the capsule. The foil, once heated up in the baking process, will disappear by evaporization. In FIG. 31, and already flat bread dough is encapsulated in such an evaporizable foil 54. And in FIG. 32, yet another way of packaging the dough is shown. Here, an-already flat dough is encapsulated in a suitable foil material 55 which can later be torn apart, either by the machine or by hand, in order to release the inlaying dough.

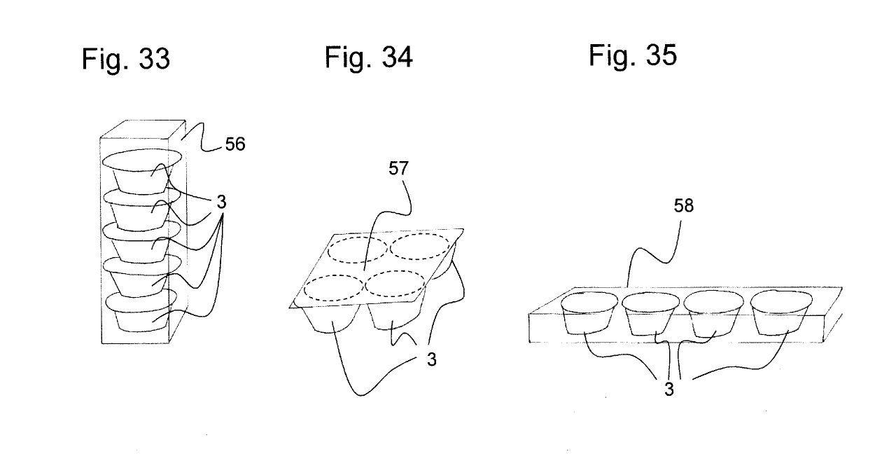

In a next section, the handling of these capsules 3 is shown and explained. FIG. 33 shows flat bread dough capsules 3 piled up and packed in a stack 56. Such stacks are then packaged in a cardboard box in which the set of capsules are being sold and handled. From this cardboard box, the capsules 3 can be inserted in to the feeding compartment 2 of the machine, or the cardboard box may itself form the feeding compartment 2 of the machine so it simply needs to be opened and put onto an insert of the machine.

In FIG. 34, an alternative packaging for the distribution and handling of capsules 3 is shown. Here, the flat bread dough capsules are arranged in a blister packaging which comprises a top foil 57 which extends over all these four capsules 3. For using the capsules 3, this top cover foil 57 will be torn away and the four still sealed capsules 3 are then separated and can be inserted into the machine. According to FIG. 35, the flat bread dough capsules 3 arranged in a row in a cardboard box 58. Likewise, the single capsules 3 can be taken out of the box and then inserted into the machine's feeding compartment 2. In FIG. 36, the insertion of a single capsule 3 into the machine is shown. In this example, the machine and the capsule 3 form a Pokayoke-system that ensures the correct insertion of the capsules 3 into the machine through a particular opening 59 in the housing 1 of the machine.

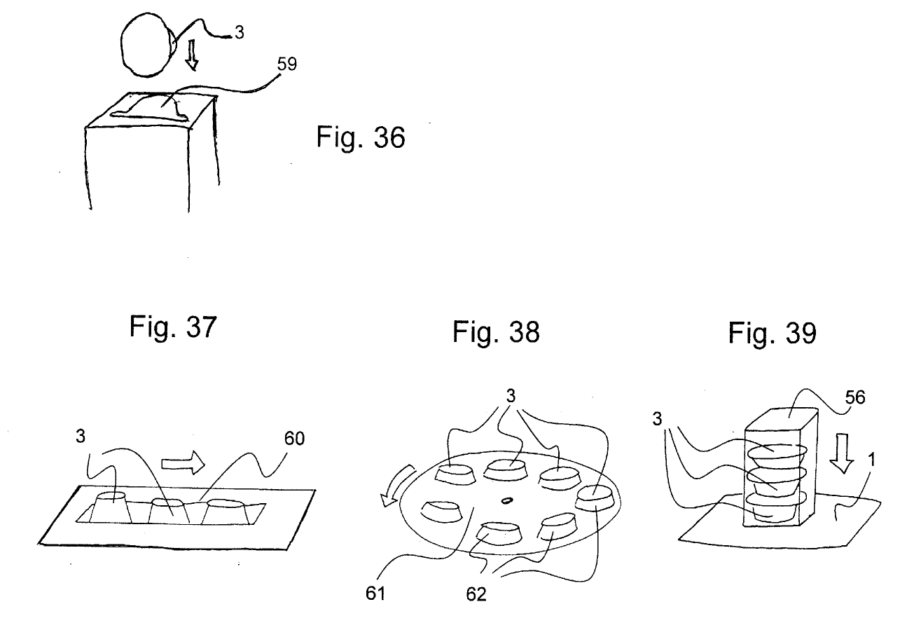

In this section, various ways of the conveying of the capsules 3 within the machine are being disclosed. In FIG. 37, a flat bread dough capsules 3 conveying system consists of a frame 60 which is put down over a row of capsules. This frame 60 is displaceable within the machine in order to feed the capsules 3 for feeding them into the opening system 5 for opening the capsules 3 and emptying them so the dough portions will fall onto the lower pressing and baking plate 8. This frame 60 can be moved by mechanical, hydraulic or pneumatic means. The conveying system according to FIG. 38 makes use of a carousel 61, which contains wholes 62. The capsules 3 are projecting out of these holes 62 from the lower side of the carousel 61 while they are laying upside down on a plate. When the carousel is rotating, the capsules 3 are being moved respectively, and once a single capsule 3 arrives over a respective hole in the lower plate so only its edge will be supported, a piston can act onto the bottom side of the capsule 3 from above, thereby bursting the sealing foil 18 and pressing the dough out so it will fall onto the baking plate 8. Then, the carousel 61 rotates again until the empty capsule 3 will fall into a recess in the lower plate, and will ultimately being disposed in the recipient container 6 for the empty capsules 3. FIG. 39 shows the cardboard box 56 containing a stack or pile of capsules 3 as already shown in FIG. 33. The cardboard box 56 is here placed on the top side of the machine housing 1, and the stack is being lowered due to gravity as the lowest capsule is falling into the conveyer system of the machine for further processing said capsule and the dough contained in it. The capsule may e.g. fall onto a conveyor belt 40, as shown in FIG. 20.

In this section, various ways of opening the capsules are being disclosed; and explained. In FIG. 40, the opening system as already mentioned and disclosed in FIG. 20 is shown in a perspective view for better understanding. At the front end of said conveyor belt 40, next to its front shaft 42, two shafts 43, 44 with rubber teeths extending away radially from the circumference of these shafts 43,44 move in different directions, the first one 43 clockwise, the adjacent one 44 at the front end in counterclock-wise direction as indicated with the arrows. The capsule 3 is shown here in an elevated state, upside down, as it will lay on the belt 40. Its opening edge 63 does extend radially and is closed and sealed with the foil 18. The foil bends away from the plane of the opening edge. In the upside-down position of the capsule 3 bends downward, as shown in the drawing. Now, when capsule 3 is being moved on the belt 40 in the direction of the arrow indicated, its foil will ultimately move into the area between the shafts 43, 44. These two shafts 43, 44 grip it and tear it down in between them, while the capsule 3 further on moves in horizontal direction over these two shafts 43, 44 and ultimately glides onto a frame 64 or onto a holding ring 45 as shown in FIG. 20. Since it the capsule 3 is now open, the dough will fall due to gravity onto the lower baking plate 8 of the machine.

Another solution for emptying the capsules 3 is shown in FIGS. 41 and 42. Here, collapsible flat bread dough capsule 3 are being used. They contain folding lines 48. The capsules 3 are positioned upside down on a support plate 68 with a hole that is of slightly larger diameter than the opening of the capsule 3. The opening edge 49 of the capsule forms a groove 50, and the entire opening edge is covered with a circular foil piece 18 that sealingly closes the capsule 3. For opening the same, a circular stationary knife 66 is arranged underneath the groove 50 which extends over almost the entire circumference, only leaving a section of approx. 20 to 30° free. On the inner side of the knife, a circular support 67 as stopper element defines how low the capsule's opening edge 49 may move against the force of a compression spring 65. For emptying the capsule 3, it will be pressed downward onto the support ring 67 by a plunger 12 or piston as shown in FIGS. 41 and 42. Once the compression spring 65 is compressed, the circular knife 66 will cut open the foil 18, then the capsule 3 will be compressed and collapse and consequently, the dough in the capsule 3 will fall over the remaining foil 18 that still hangs at the edge over a little remaining material bridge where the circular knife 66 is interrupted and did not act. Thereby, the dough does not touch any part of the machine. This is crucial for keeping the best hygienic level. Not even the circular knife 66 will touch the dough. The dough merely touches the inner side of the capsule 3 and the inner side of the foil 18, and will freely fall unto the lower baking plate 8. In an alternative embodiment, a thermic opening of the foil by using a heated up wire that is being pressed against the foil may be an option.

FIG. 43 shows a system for opening ball-shaped capsules 3. The knobs 53 at the zeniths of the two hemispheres 52 or hemispherical shells 52 are guided by rails 69. For opening the capsule 3, the rails 69 are spreading away from each other and the capsule 3 is mechanically pushed by a plunger in the direction as indicated with an arrow. Therefore, the two hemispherical shells 52 are being pulled apart and the dough falls down. The hemispherical shells 52 will then leave the rails 69 at their ends and fall into the recipient container 6 for the empty capsules 3.

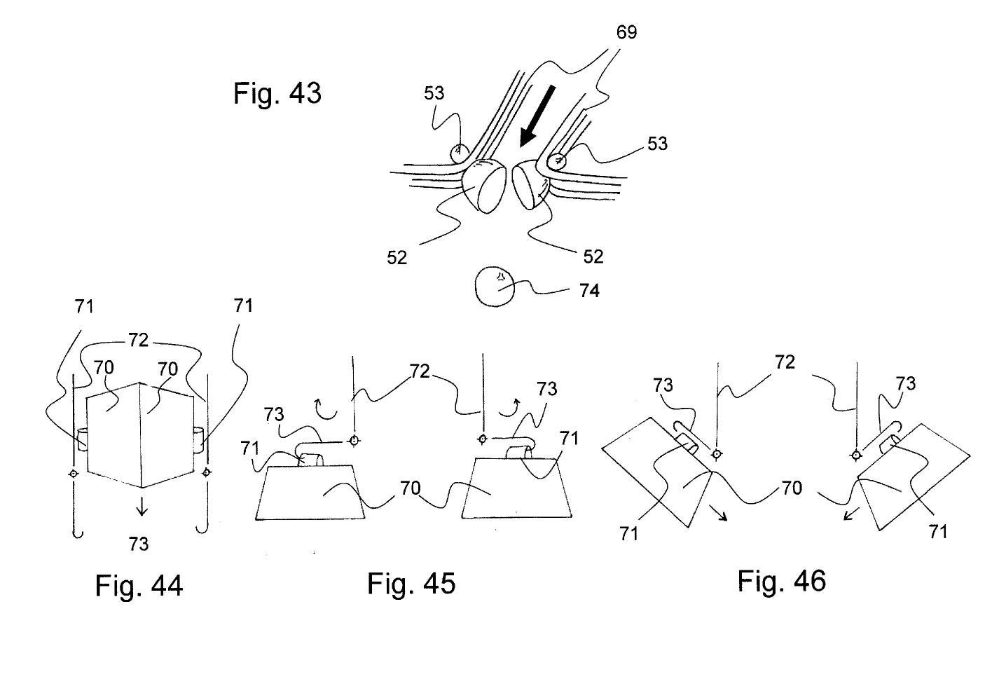

FIGS. 44 to 46 disclose yet another method for opening respective capsules 3. A single capsule 3 consists of two halves 70 that are hermetically sealed along their openings. On the outer side these halves are equipped with orifices 71. The opening system comprises two rails 72, and on their lower end, swivelable rail hooks 73 are attached which can be activated by a motor. As shown in FIG. 44, a capsule 3 of that sort falls down and its orifices 71 will fall into the hooks 73 of the swivelable rail hooks 73. In a second step, the rail hooks 73 are being swiveled apart from each other as shown in FIG. 45. This will open the capsule. Its two halves 70 are rotated in a position where their openings are on the lower side. Consequently, the dough falls down due to gravity. Then, the rail hooks 73 are further rotated until the reach the position as shown in FIG. 46. Now, the empty halves 70 will themselves fall down due to gravity, and they can slide on a pathway down into the recipient 6 for the empty capsules.

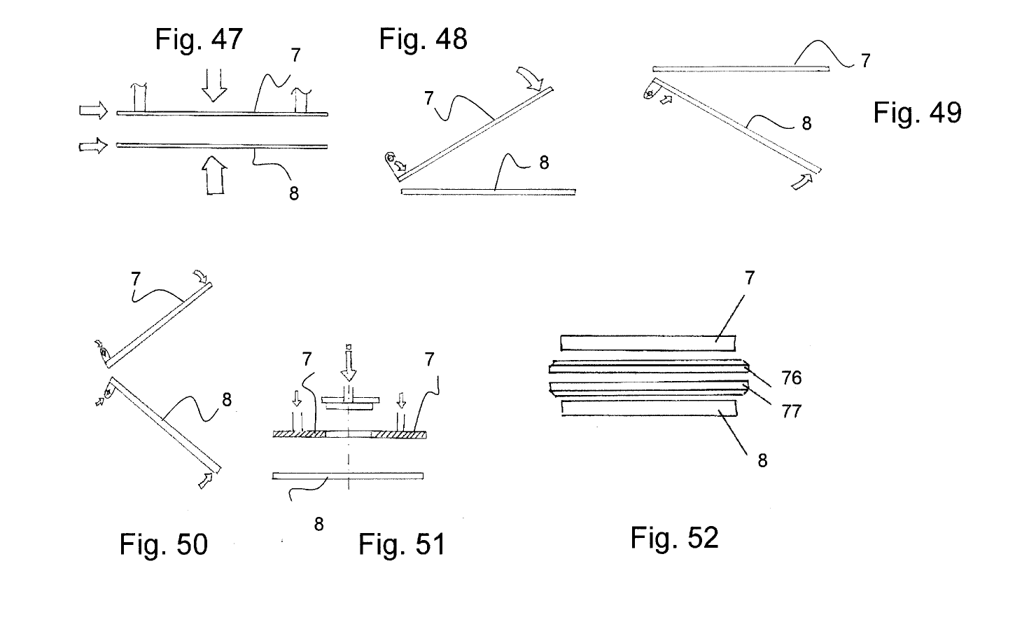

In FIG. 47, press and baking plates 7, 8 for a parallel closing and flattening of the dough balls are shown. It is advantageous if the plates move always parallel to each other for pressing. Then, a ball-like dough will be flattened equally to each of its sides and ultimately, a circular flat dough can be obtained. In FIG. 48, press and baking plates 7, 8 are shown with a lower horizontal resting plate 8 and an upper swiveling plate 7 for flattening the dough balls. In such an arrangement, additional means will be needed in order to remove the finished baked flat bread form the lower plate 8. In FIG. 49, the press and baking plates 7, 8 comprise an upper horizontal plate 7 and a lower swiveling plate 8 for flattening the dough balls and subsequently releasing the flat dough by swiveling the lower plate 8 downwardly as shown. In FIG. 50, the press and baking plates 7, 8 are both swiveling plates for flattening the dough balls and subsequently releasing the flat dough. In FIG. 51, the lower press and baking plate 8 is a horizontal plate 8, as also the upper plate 7. In order to feed the dough, the upper plate 7 comprises a hole and a stamp which fits into this hole in order to obtain a flat lower surface of said upper plate 7. The stamp can move up and down as the entire upper plate 7 can move up and down for pressing and baking. FIG. 52 discloses press and baking plates 7, 8 which comprise releasable, separate heating plates 76, 77, preferably coated with a Teflon or ceramic layer, so they can easily be removed for cleaning purposes. The pressing and heating or baking plates 7, 8 can have a ceramic or Teflon coating so the doughs are not adhering to them. In general, the press and baking plates must be stiff to sustain forces but also a bit flexible.

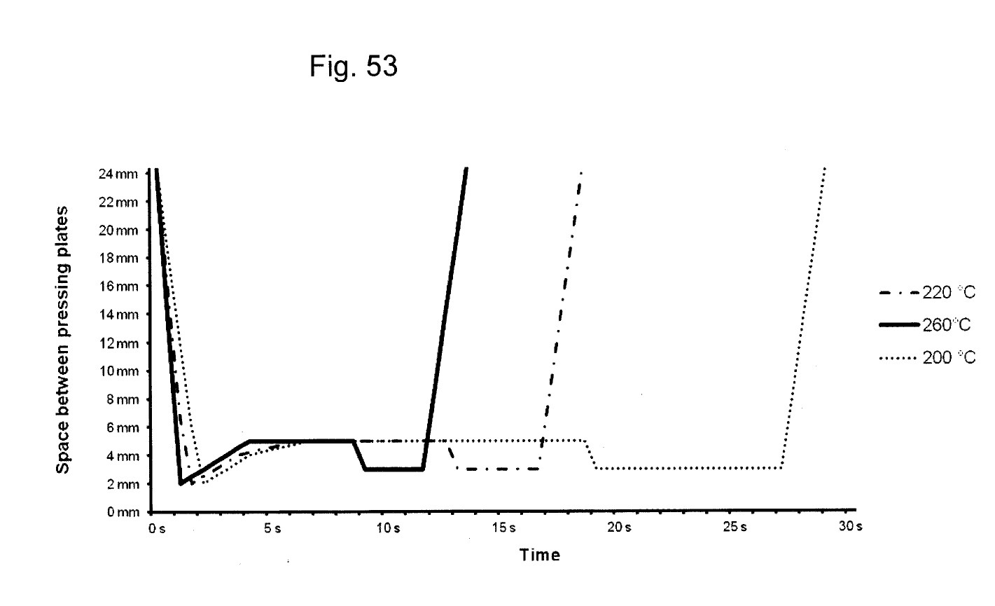

FIG. 53 does show a table presenting the pressing and heating process by showing the distance between the heating plates versus the time for three different temperatures, that is for 220° C., for 260° C. and for 200° C. The dough sticks to the plates, therefore low adhesion plates have to be used to reduce the resistance and therefore reducing the pressing force. The pressing force for a wheat dough is substantially higher than for a corn dough. Typically, the pressing force will be adjusted by controlling the machine in such manner that the pressing plates are moving toward each other, after they have been heated up to the required temperature, and then moving until a distance between them of only some 2 mm will be reached. After a couple of seconds, the pressing force will be lowered so the plates will move apart to a distance of approx. 5 mm. This will allow the dough and the wheat in it to release moisture. Ultimately, after a few seconds, another increased pressing force is activated to press the plates to a distance of again 2 mm. The higher the temperatures of the baking plates, the shorter is the baking time. The temperature of the plates may also be varied during the baking process. This is a matter of experience and control of the heating means, and it depends on the particular composition of the dough. If a resistor heating is being used, approx. 1800 W of power is needed in order to reach a temperature of 200 to 260° C. in a short enough time. Inductive heating is an option.

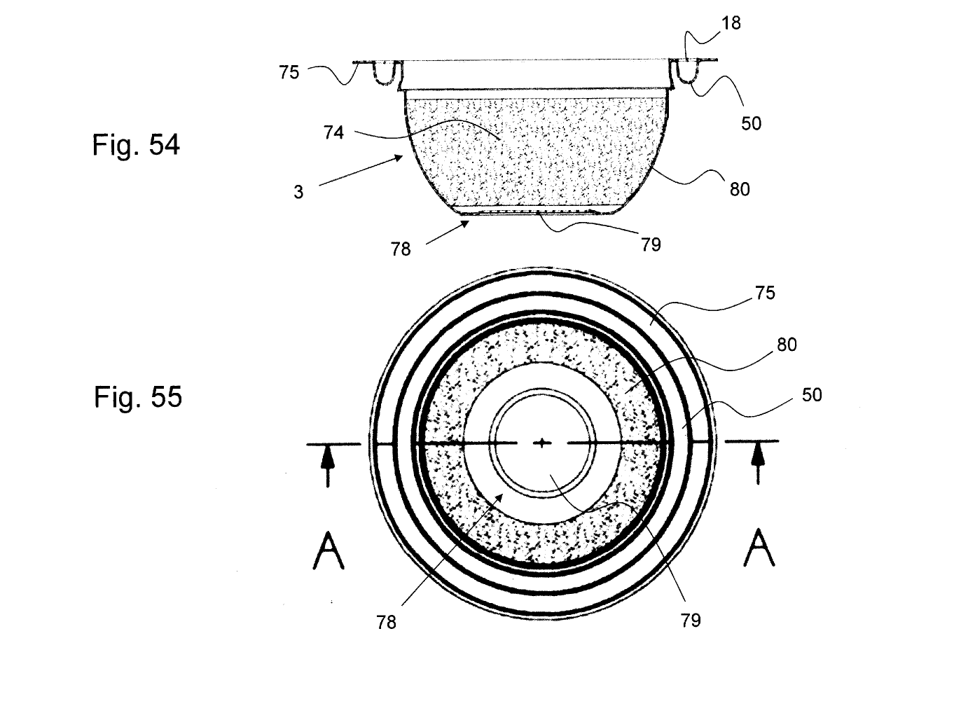

In FIG. 54, a section view of a dome-like capsule 3 is shown, bottom down. This capsule 3 for receiving a portion of dough for producing a single flat bread comprises two parts which are sealingly closable for gas-tightly encapsulating a dough portion 74 for making one single flat bread. The capsule 3 comprises a hollow part in the form of a domelike can 80 can made of a laminate and an even sealing foil 18 to be sealingly welded onto the hollow part 69, for gas-tightly encapsulating a portion 74 of flat bread dough. Instead of a dome-like shape the capsule 3 can also form a semispherical, halfball-like part or a cylindrical or conical cup-like part. The capsule 3 forms an edge 75 at its open side which is extending radially in a horizontal plane over the diameter of the hollow part of the can 80, and that the edge 75 forms a surrounding groove 50 so as to weld or glue the sealing foil 18 onto the outer side of the edge 75 along the outer side of the groove 50. The foil 18 thereby spans over this groove 50. The bottom 78 of this capsule forms a central recess 79 which is approx. 0.5 mm elevated from the lowest surrounding part.

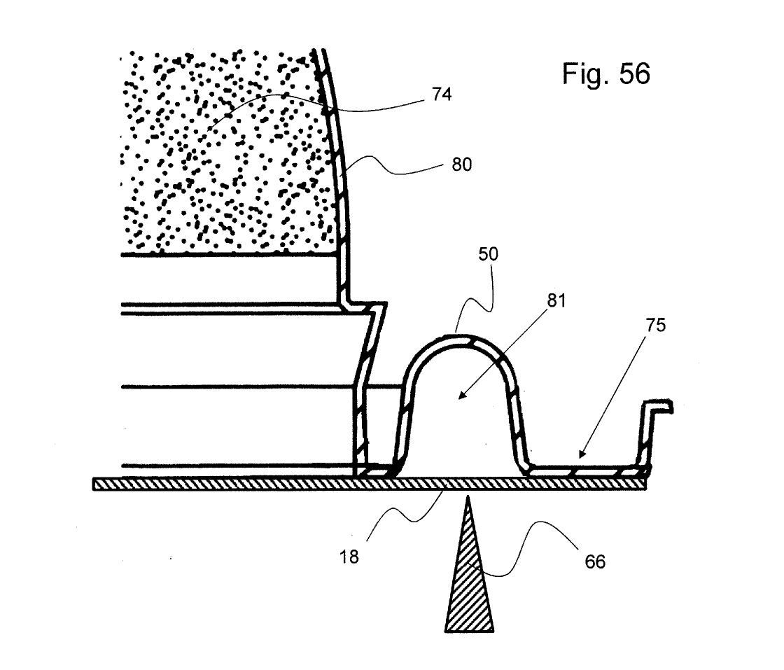

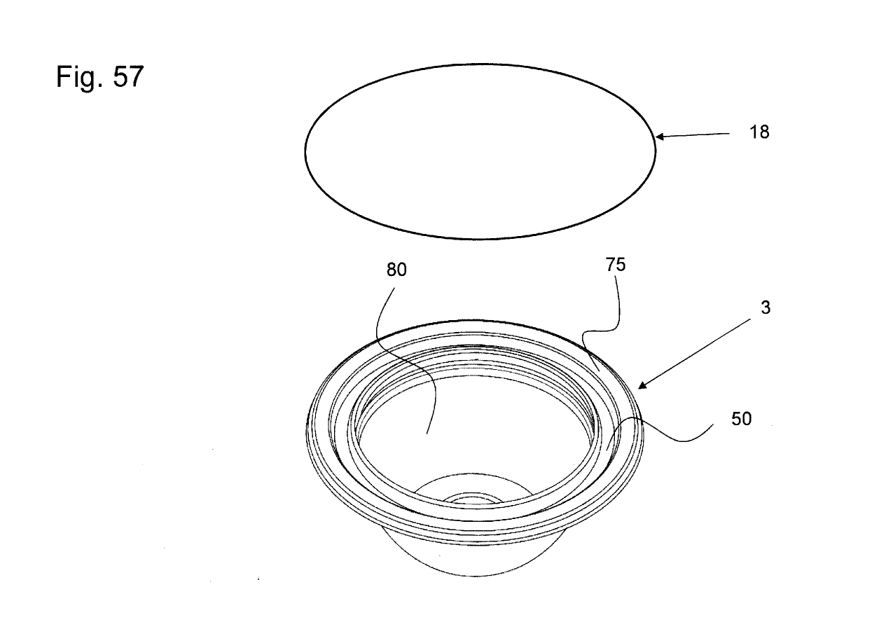

FIG. 55 shows this capsule 3 when seen onto the bottom side 78. The line A-A designates the line along which the section view the capsule is shown in FIG. 54. FIG. 56 shows an enlarged view of the circumferential edge 75 of the dome-like capsule 3. This edge section 75 forms the circumferential groove 50 and the foil 18 is glued or welded onto this edge 75 spanning over the groove 50 so a hollow ring 81 is obtained. When the capsule 3 in this upside down position, with dome-like cup 80 on the upper side, is pressed onto the circular knife 66 of which only a section view is shown here, said knife 66 will cut the foil 18 open by penetrating into the hollow ring 81 formed by the groove 50. The circular knife 66 is interrupted at one point in order to leave the foil 18 intact at this location. The capsule 3 can then be pressed upside down onto this circular stationary knife 66 arranged underneath the groove 50 in an apparatus, and said knife 66 extends almost over the entire circumference, leaving only a section of 5° to 30° free. By pressing down the foil 18 onto this knife 66 by acting with a plunger from above onto the capsule 3, the foil 18 will be cut open by the knife 66 along a circumference of 330° to 355° and the foil 18 will fold down around the remaining intact foil part of the circumference and is held by this remaining material bridge of foil. As a consequence, the encapsulated dough portion 74 will fall out of the capsule 3 without touching any parts other than the only interior side of the capsule 3 and the inner part of the foil 18 and therefore without touching any part of the machine directly. It will fall onto the heating plate to be pressed flat and bakened. Eventually, FIG. 57 shows a perspective view of the open capsule 3, with its sealing foil above.

### LIST OF NUMERALS

1 housing of the machine
2 feeding compartment
3 capsules
3′ lowest capsule in stack
3″ already upside-down turned capsule
4 conveyor system
5 opening system
6 waste recipient
7 upper heated baking plate
8 lower heated baking plate
9 ready flat bread recipient
10 warming keeping system
11 row of capsules
12 plunger
13 press
14 piston for moving lower baking plate 8
15 front side of machine
16 rear side of machine
17 container for capsules
18 gas-tight foil
19 finger for turning the capsules around 180°
20 rotatable disc with fingers 19
21 rotation axis of disc 20
22 cylindrical wall (gliding surface for capsules)
23 struts in cylinder
24 inner cylindrical wall
25 swiveling axis of lower plate 8
26 lower guiding rails
27 dispensing slit
28 guiding rails for tearing halves capsule apart
29 holding plate with central hole
30 bolts
31 upper guiding rails for bolt 30
32 front end area of guided rails 31
33 spring loaded separators
34 knee-knuckle press mechanism
35 lever
36 lever
37 central joints
38 second separator
39 cover plate
40 conveyor belt for capsules
41 shaft
42 shaft
43 shaft with rubber teeths for tearing off the foil 18
44 shaft with rubber teeths for tearing off the foil 18
45 holding ring
46 rotation axis of upper plate 7
47 actuator
48 folding lines on capsule
49 edge of capsule with groove
50 circular groove
51 weakened line in foil 18
52 hemispherical shells
53 knobs in zenith of hemispherical shells
54 evaporizable foil
55 foil material for flat dough
56 stack with several capsules
57 top foil of blister packaging
58 cardboard box for capsules 3
59 opening in housing for inserting capsule
60 frame for conveying capsules
61 carousel
62 wholes in carousel
63 opening edge of capsule
64 frame
65 compression spring
66 circular stationary knife
67 circular support as stopper
68 support plate
69 rails for knobs of hemispherical capsule parts
70 halves of capsule
71 orifices of halves 70
72 rails of opening system (FIG. 44)
73 rail hooks
74 dough portion
75 leading pipe
76 releasable separate heating plate
77 releasable separate heating plate
78 bottom of can 80
79 can (FIG. 54)
80 dome-like can
81 hollow ring due to groove beneath foil

What is claimed is:

1. A capsule for receiving a portion of dough for producing a single piece of flat bread, comprising a first part and a second part sealingly closable for gastight encapsulation of a dough portion in a hollow portion for making a single piece of flat bread.

2. The capsule for receiving a portion of dough for producing a single piece of flat bread according to claim 1, wherein said first part includes a dome part with a radially extending circular edge section forming a groove along the circumference of said edge which extends with its depth into the direction of the side of the dome part and a sealing foil which spans over the opening of the dome part and the edge section and groove and is sealingly weldable or gluable onto the edge section.

3. The capsule for receiving a portion of dough for producing a single piece of flat bread according to claim 1, wherein the first part includes a cylindrical can with a radially extending circular edge section at its opening, and which edge section forms a groove along the circumference of said edge which extends with its depth into a direction of a side of the cylindrical can and a sealing foil spanning over the opening of the cylindrical can and the edge section and groove and is sealingly weldable or gluable onto the edge section.

4. The capsule for receiving a portion of dough for producing a single piece of flat bread according to claim 1, wherein the first part includes a spherical part with a radially extending circular edge section at its opening, and which edge section forms a groove along the circumference of said edge which extends with its depth into the direction of the side of the spherical part and a sealing foil spanning over the opening of the spherical part and the edge section and groove and is sealingly weldable or gluable onto the edge section.

5. The capsule for receiving a portion of dough for producing a single piece of flat bread according to claim 1, wherein the first part including a hemispherical part with a radially extending circular edge section at its opening, said edge section forms a groove along circumference of said edge which extends with its depth into the direction of the side of the hemispherical part and a sealing foil spanning over the opening of the hemispherical part and the edge section and groove and is sealingly weldable or gluable onto the edge section.

6. The capsule for receiving a portion of dough for producing a single piece of flat bread according to claim 1, wherein the first part includes a conic cup with radially extending edge as said capsule, and said edge section forms a groove along the circumference of said edge which extends with its depth into the direction of the side of the conic cup, and the cup having pre-determined folding lines for rendering said capsule collapsible, and a sealing foil spanning over the opening of the cup and the edge and is sealingly weldable or gluable onto the extending edge.

7. The capsule for receiving a portion of dough for producing a single piece of flat bread according to claim 1, wherein the first part and the second part each comprising a hemispherical part and these two parts are sealingly weldable or gluable together along their edges.

8. The capsule for receiving a portion of dough for producing a single piece of flat bread according to claim 1, wherein the first part forms a cylindrical can with a radially extending edge at its open side, and a foil sealingly weldable or gluable onto the edge of the cylindrical can.

9. The capsule for receiving a portion of dough for producing a single piece of flat bread according to claim 1, wherein the first part and the second part each comprising a hollow cylindrical part with one side of the cylinder closed and forming a radially extending edge section while one part is tightly fitting into the other part, and the edge of the cylinder of the larger part is weldable or gluable onto the edge of the smaller part.

10. The capsule for receiving a portion of dough for producing a single piece of flat bread according to claim 1, wherein the material of the capsule is one of a soft material, a flexible material, a rigid material and a semi-rigid material and of a combination thereof.

11. The capsule for receiving a portion of dough for producing a single piece of flat bread according to claim 1, wherein the material of the capsule is one of aluminum, paper, paperboard, can or canister, plastic or polymeric material.

12. The capsule for receiving a portion of dough for producing a single piece of flat bread according to claim 1, wherein the material of the capsule is an laminate made of at least one layer of aluminum, paper, paperboard, can or canister, plastic or a polymeric material.

13. The capsule for receiving a portion of dough for producing a single piece of flat bread according to claim 1, wherein the material of at least one part is made of biodegradable material made of sugar-cane extract.

14. The capsule for receiving a portion of dough for producing a single piece of flat bread according to claim 1, wherein the material of at least one part is made of biodegradable material made of a polylactic acid (PLA) blend.
